(19) United States
(12) Patent Application Publication
(10) Pub. No.: US 2013/0312620 A1
(43) Pub. Date: Nov. 28, 2013

(54) DEVICE FOR INSERTING CAPSULES

(71) Applicant: Alain Mariller, Le Mont - Pelerin (CH)

(72) Inventor: Alain Mariller, Le Mont - Pelerin (CH)

(73) Assignee: ETHICAL COFFEE COMPANY SA, Fribourg (CH)

(21) Appl. No.: 13/983,426

(22) PCT Filed: Jan. 30, 2012
(86) PCT No.: PCT/IB2012/050411

§ 371 Date: Aug. 2, 2013

(30) Foreign Application Priority Data
Feb. 4, 2011 (IB) PCT/IB2011/050500

(51) Int. Cl. A47J 31/40

(52) U.S. Cl. CPC A47J 31/407
USPC 99/295

(57) ABSTRACT

Device for inserting capsules (1), e.g. coffee capsules, comprising a passage (2) through which the capsule is transferred and which is characterised by a cross section smaller than the cross section of the capsule.

### FIELD OF THE INVENTION

The present invention concerns the production of a beverage by passing hot water through a capsule containing a dose of product, for example coffee.

### PRIOR ART

Coffee machines are known, see for example that which is described in EP 2 103 236 A1, which comprise a device for the insertion of a capsule. This device comprises a passage through which the capsule is introduced. The cross section of this passage is slightly greater than the cross section of the capsule. “Cross section” is understood to mean the area defined according to a plane which contains the axis of symmetry of the capsule.

Once it has been introduced, the capsule is situated in a position designated the extraction position.

The passage is therefore dimensioned so as to easily guide the capsule up to its extraction position.

The capsule insertion devices of the prior art have, however, the disadvantage of not ensuring a firm positioning of the capsule on its introduction into the machine.

This type of disadvantage is also to be observed in certain devices which have a passage similar to the one previously stated, but arranged between the extraction position and the site of recovery of the capsule.

This disadvantage results from the fact that the cross section of the passage is slightly greater than that of the capsules.

A need therefore exists to remedy this problem in particular.

### GENERAL DISCLOSURE OF THE INVENTION

The problem which the present invention proposes to solve lies in an improvement of the positioning of the capsule on its introduction into the machine and/or on its ejection from its extraction position.

The invention builds on the fact that the majority of the capsules have a lateral wall which is provided with a certain flexibility. It is therefore possible to substantially deform the wall of these capsules without destroying them, and hence possible to ensure an optimum guidance of the capsule in the machine.

The present invention therefore has as an object a device for inserting and/or ejecting capsules, e.g. coffee capsules, comprising a passage through which the capsule is transferred and which is characterized by a cross section smaller than the cross section of the capsule.

Various embodiments of the invention are described in the claims.

### DETAILED DISCLOSURE OF THE INVENTION

The invention is described in greater detail below by means of examples illustrated by the following figures:

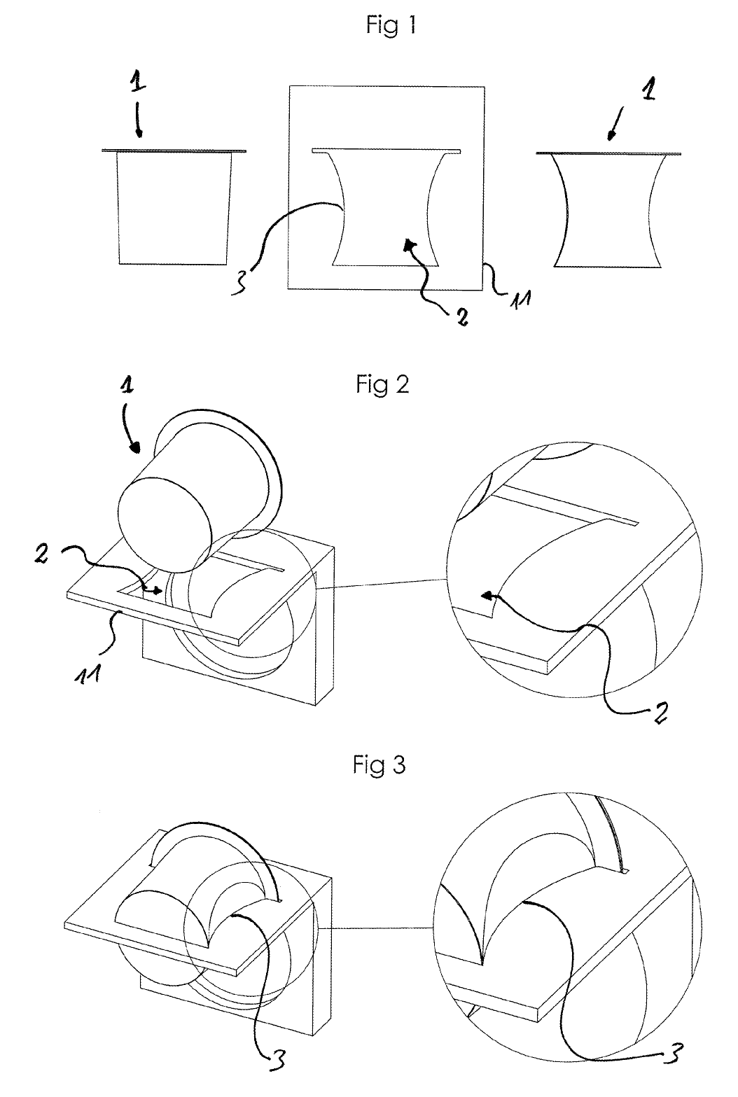

FIG. 1 represents a top view of a capsule before and after having passed through a passage.

FIG. 2 represents a capsule before its transfer across the passage.

FIG. 3 represents a capsule in its position through the passage.

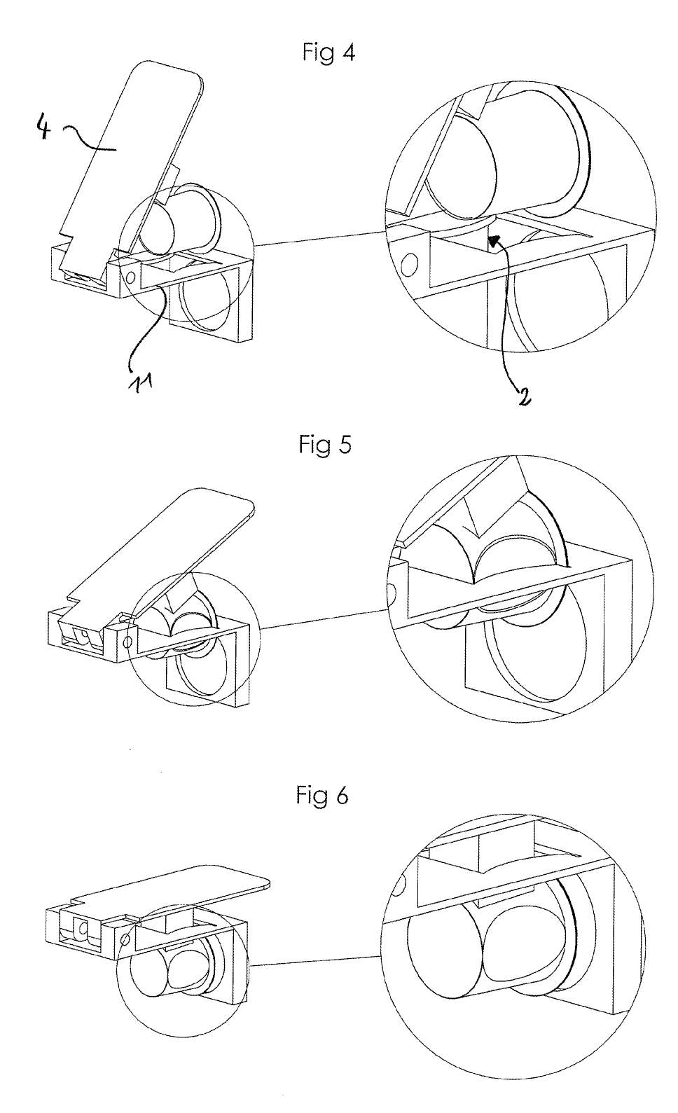

FIGS. 4 to 6 represent the successive steps of the introduction of a capsule by means of a lever.

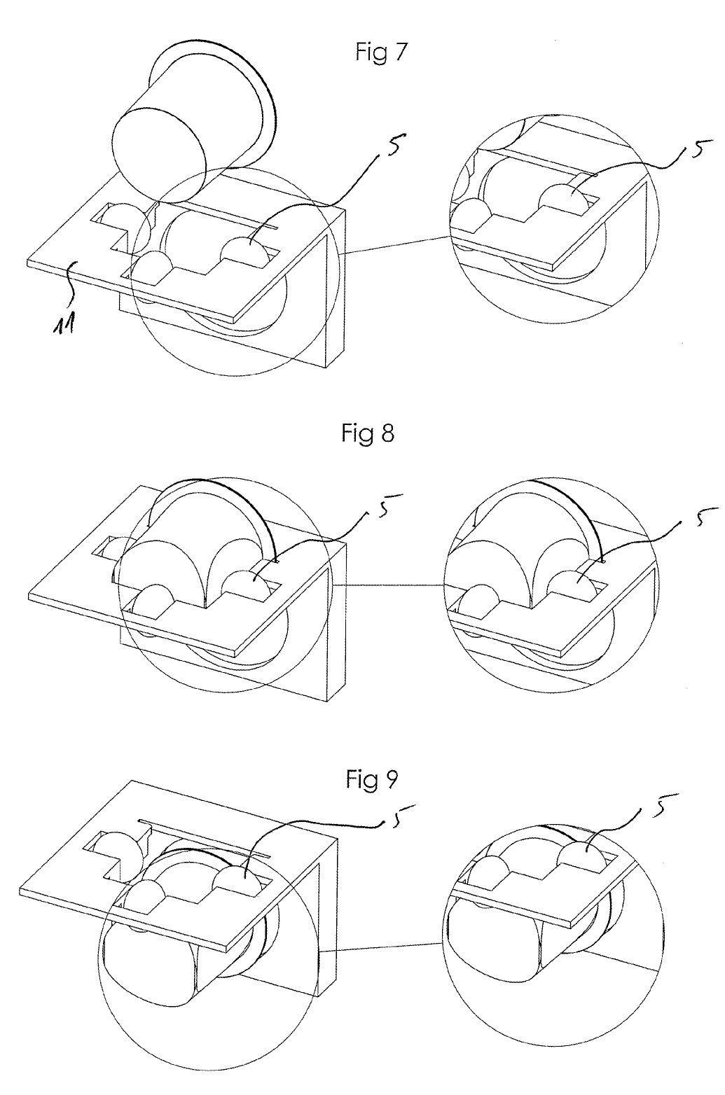

FIGS. 7 to 9 represent the successive steps of the introduction of a capsule across a passage having a particular arrangement.

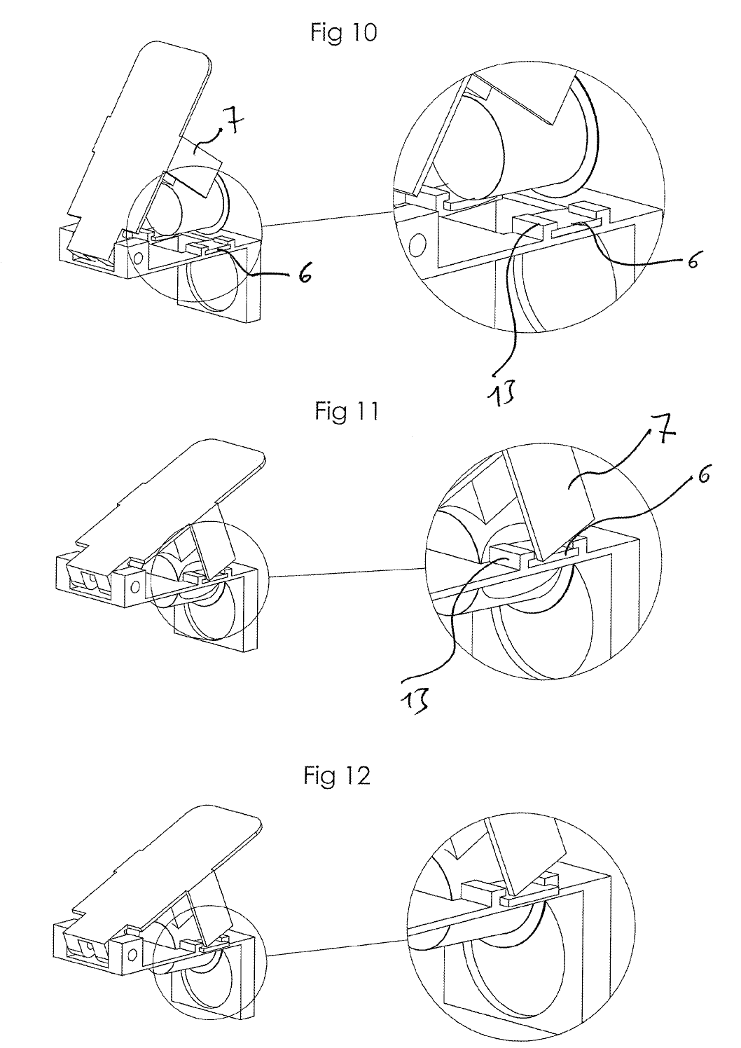

FIGS. 10 to 12 represent the successive steps of the introduction of a capsule across a passage, the cross section of which has a modifiable contour.

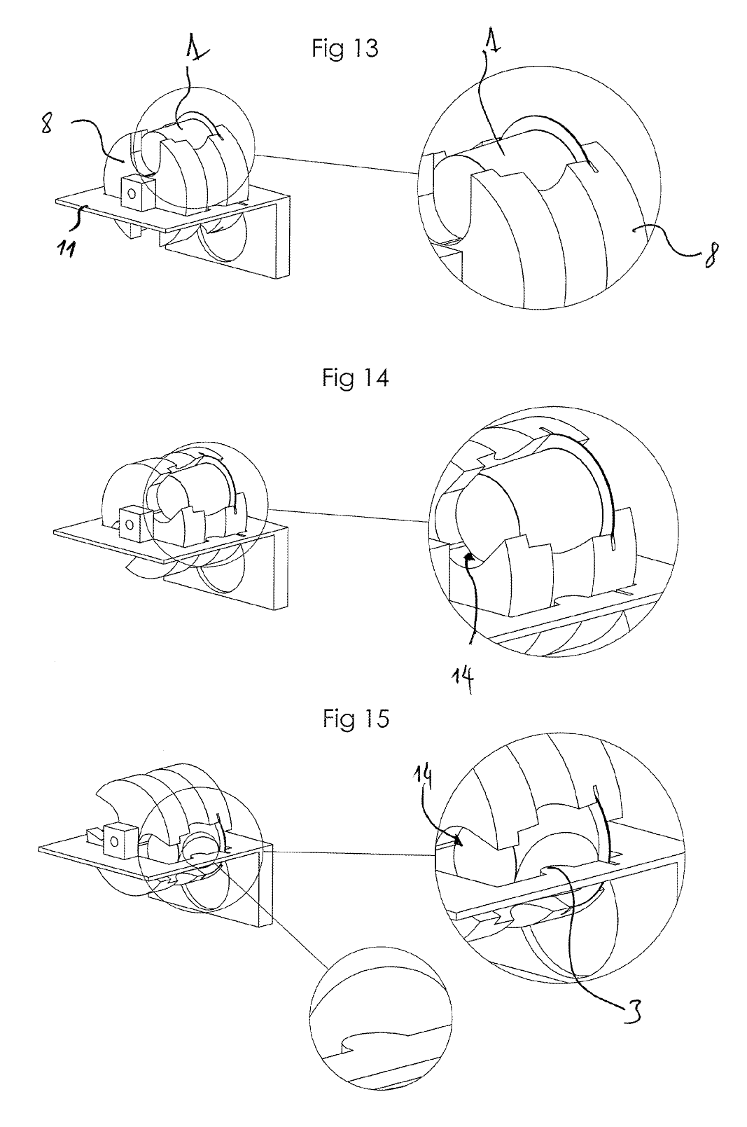

FIGS. 13 to 15 illustrate a capsule introduction mechanism through a passage.

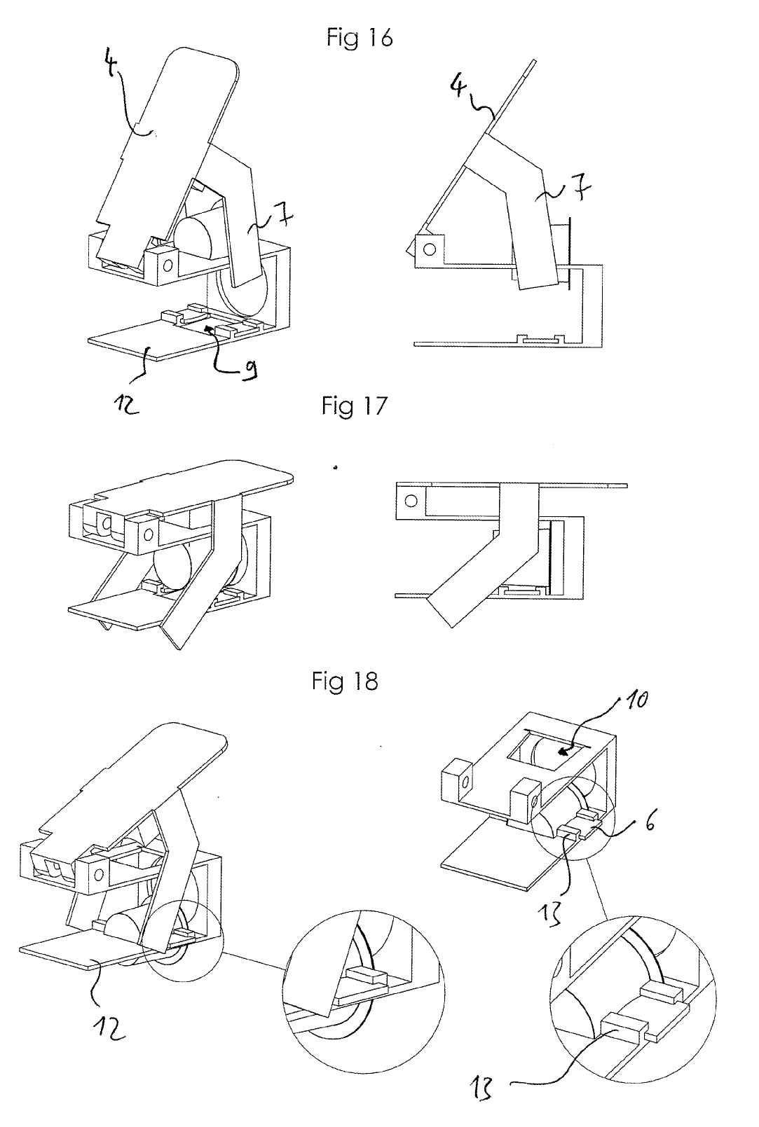

FIGS. 16 to 18 illustrate a variant in which the passage having reduced cross section is arranged between the extraction position and the site of recovery of the capsule.

### LIST OF THE NUMERICAL REFERENCES

1. capsule
2. passage
3. deformation zone
4. lever
5. roller
6. small plate
7. retaining element
8. drum
9. lower passage
10. upper passage
11. upper plate
12. lower plate
13. guiding element
14. housing

FIG. 1 represents a plate 11, 12 (centre figure) in which a passage 2 is arranged, the cross section of which is smaller than the cross section of a capsule 1 in normal state (left figure). More precisely, the passage 2 has a height which is substantially identical to the height of a capsule 1 and a width which is reduced with respect to the width of the capsule 1. The zone of reduced width constitutes a deformation zone 3 of the capsule.

Once the passage 2 is passed through, the capsule 1 is deformed (right figure) and its cross section is substantially identical to the cross section of the passage 2.

The plate 11, 12 can be arranged at an upper level, i.e. upstream of the extraction position, or at a lower level, namely downstream of the extraction position.

Obviously, only capsules having a certain flexibility, i.e. capsules able to undergo a sufficient elastic or plastic deformation, can pass through the passage without being damaged. If the coefficient of rigidity of the capsule is too high, the capsule can not pass through the passage.

FIGS. 4 and 5 illustrate a variant of the invention, in which the transfer of the capsule 1 through the passage 2 is ensured by a lever.

In the variant illustrated in FIGS. 7 to 9, the deformation zones are present in the form of rotary rollers 5, the rotation axis of which is situated in the plane defined by the plate 11.

In the variants 10 to 12 and 16 to 18, the deformation zones are present in the form of mobile small plates 6 able to slide through guiding elements 13 arranged towards the edge of the passage 2.

The movement of the small plates 6 can held by means of a retaining element 7 fixed to the lever 4.

The variant illustrated in FIGS. 13 to 15 represents a drum 11 including at least one housing intended to receive temporarily a capsule 1. Initially, a new capsule 1 is introduced into the housing 14. The drum 11 then carries out a rotation, in general of 180°, during which the capsule 1 passes through the passage 2.

The embodiment of FIGS. 16 to 18 represents a reduced cross section arranged in a lower plate 12.

In this case, the passage 10 arranged in the upper plate 11 includes a cross section substantially identical to the cross section of the capsule, i.e. a cross section without a deformation zone.

The retaining element 7 has an angle so as to release the small plates 6 once the lever is completely lowered.

Obviously, other geometries of reduced cross section can be used with the lower plate 12, as for example those of FIGS. 1 to 9.

It goes without saying that the invention is not restricted to a particular cross section shape, but any cross section permitting the sought effect to be obtained.

1. A device for inserting and/or ejecting capsules, for example coffee capsules, comprising a passage through which the capsule is transferred and which is characterized by a cross section smaller than the cross section of the capsule.

2. The device according to claim 1, in which the cross section of the passage is narrower than the cross section of the capsule at the level of the lateral wall of the capsule.

3. The device according to claim 1, in which the said smaller cross section is formed in a plate.

4. The device according to claim 1, in which the said smaller cross section is formed by means of elements such as small plates or rollers arranged on the periphery of a passage of cross section equal to or greater than the cross section of the capsule.

5. The device according to claim 1, intended for capsules of frustoconical shape.

6. The device according to claim 1, in which the passage is arranged between the site of introduction of the capsule in the machine and the extraction zone.

7. The device according to claim 1, in which the passage is arranged between the extraction zone and the site of recovery of the capsule.
